(19) United States
(12) Patent Application Publication
(10) Pub. No.: US 2010/0239221 A1
(43) Pub. Date: Sep. 23, 2010

(54) FIBER CLEAVING DEVICE

(76) Inventors: Roger E. Robichaud, Bozeman, MT (US); Jess Tode, Bozeman, MT (US); Ken Beldring, Bozeman, MT (US)

Correspondence Address: ANTOINETTE M. TEASE, P. O. BOX 51016, BILLINGS, MT, 59105, US

(21) Appl. No.: 12/408,090

(22) Filed: Mar. 20, 2009

(51) Int. Cl. G02B 6/00

(52) U.S. Cl. 385/136

(57) ABSTRACT

A fiber cleaving device comprising a clamp assembly, central moveable stage, right moveable stage, and diamond component. The diamond component comprises a diamond and a diamond oscillator. The clamp assembly secures a piece of bare glass fiber so that it is oriented roughly perpendicularly to the cutting edge of the diamond. The central moveable stage moves the diamond oscillator forward so that the cutting edge of the diamond comes into contact with the piece of bare glass fiber. The right moveable stage pulls the piece of bare glass fiber taught after it has been secured by the clamp assembly. The diamond oscillator is configured so that the diamond cleaves the piece of bare glass fiber at an effective cutting angle of approximately forty-five degrees or, alternately, in the range of thirty to sixty degrees.

### BACKGROUND OF THE INVENTION

1. Field of the Invention

The present invention relates generally to the field of cleaving optical fibers, and more specifically, to a fiber cleaving device that incorporates an oscillating cutting diamond supported by a tabletop that presents the diamond to the fiber at an effective cutting angle of approximately forty-five (45) degrees.

2. Description of the Related Art

For the vast majority of fiber optic applications, it is important to cleave the fiber such that the end of the fiber is completely flat in preparation for splicing. In producing a cleave, the first step is to place the fiber under tension, and the second step is to score the fiber, thereby initiating the cleave. The resulting cleave angle and surface features are a direct result of both the initial strain distribution in the fiber after clamping and the diamond's score quality.

The object of the cleaving process is to produce a featureless flat surface on the end of the fiber so that the ends of the fibers can be spliced together effectively. The ends of the fibers may be spliced together either mechanically or by fusing them together with an electric arc. If the ends of the fibers are not flat, then either splicing will not be possible, or else the splice will be imperfect, resulting in a loss of data transmission or inefficient data transmission from one fiber to another.

Prior to cleaving, the fiber must be clamped on either side of the cleaving site. This clamping process must be accomplished without introducing any bending or torsion in the fiber. If there is torsion or bending in the fiber as a result of clamping, then the cleave angle will be affected.

The diamond itself also has a significant impact on the resulting cleave angle and surface quality. Specifically, the cutting edge of the diamond must be perpendicular to the axis of the fiber (see FIG. 12). Additionally, the bisector of the cutting angle of the diamond must be perpendicular to the axis of the fiber (see FIG. 13). As the diamond approaches the fiber, the cleave should occur immediately upon contact. If the cleave is delayed, the fiber will bend before cleaving occurs. This bending action may introduce nonsymmetrical stress in the fiber, which will result in a cleave angle greater or less than ninety (90) degrees. To ensure that the cleave occurs immediately, the diamond must impact the fiber at sufficient velocity, and the cutting edge of the diamond must be as sharp as possible.

The present invention combines the advantages of placing the fiber under tension without bending or torsion in the fiber, maintaining the cutting edge of the diamond and the bisector of the cutting angle of the diamond at a ninety-degree (90°) angle to the axis of the fiber, and impacting the diamond at sufficient velocity to cause the cleave to occur immediately. The present invention also allows the position at which the diamond impacts the fiber to be adjusted over time so as to maintain a constantly sharp cutting edge.

Furthermore, the present invention uses oscillation of the diamond toward and away from the axis of the fiber to achieve a high-impact velocity. The oscillation direction of the diamond is at a forty-five-degree (45°) angle to the fiber, producing a slicing motion and presenting a sharper edge to the fiber, thereby facilitating the initiation of the cleave. The concept of using an oscillating diamond to cut fiber was described in U.S. Pat. No. 4,790,465 to Fellows et al. Unlike the prior art, however, the present invention places the oscillating diamond on a tabletop that oscillates at a forty-five-degree (45°) vertical angle to the axis of the fiber. This configuration results in the diamond approaching the fiber at a roughly forty-five-degree (45°) angle, which presents a sharper edge to the fiber and produces an instantaneous score upon contact. The specifies of the present invention are discussed more fully below.

### BRIEF SUMMARY OF THE INVENTION

The present invention is a fiber cleaving device comprising a clamp assembly; a central moveable stage; a right moveable stage; and a diamond component; wherein the diamond component comprises a diamond and a diamond oscillator; wherein the diamond comprises a cutting edge, and the clamp assembly secures a piece of bare glass fiber so that it is oriented roughly perpendicularly to the cutting edge of the diamond; wherein the central moveable stage moves the diamond oscillator forward so that the cutting edge of the diamond comes into contact with the piece of bare glass fiber; wherein the right moveable stage pulls the piece of bare glass fiber taught after it has been secured by the clamp assembly; and wherein the diamond oscillator is configured so that the diamond cleaves the piece of bare glass fiber at an effective cutting angle of approximately forty-five degrees.

In a preferred embodiment, the diamond oscillator comprises an oscillator table, a lower oscillator leg, and an upper oscillator leg; the lower and upper oscillator legs are at a roughly forty-five-degree angle relative to the oscillator table; the diamond oscillator is connected to a coil core; the diamond is attached to the oscillator table, and the oscillator table comprises a tabletop and a table base; narrow gaps exist between the coil core and the lower oscillator leg and between the coil core and the table base; a coil is wrapped around part of the coil core; when current pulses flow through the coil, corresponding magnetic flux flows across the narrow gaps between the coil core and lower oscillator leg and between the coil core and table base, generating force of attraction impulses between the coil core and table base and between the coil core and lower oscillator leg; and the diamond oscillator has a resonant frequency, and the force of attraction impulses are set at approximately the resonant frequency of the diamond oscillator. Preferably, the oscillator table resonates at approximately fifty kilohertz.

In a preferred embodiment, the clamp assembly comprises a left clamp and a right clamp; the left clamp comprises an acrylic plate with a scale that is used to measure the length of an exposed glass section of fiber. Preferably, the present invention further comprises a main body; the main body comprises a first magnet and a second magnet; the clamp assembly comprises a left clamp and a right clamp; the left clamp comprises an acrylic plate with an embedded ferromagnetic shaft; the ferromagnetic shaft of the left clamp is situated directly on top of the first magnet when the left clamp is in a closed position; the right clamp comprises a ferromagnetic plate with a first end; and the first end of the ferromagnetic plate is situated directly on top of the second magnet when the right clamp is in a closed position.

In a preferred embodiment, the left clamp comprises a pivotable handle to facilitate lifting of the left clamp off of the first magnet, and the right clamp comprises a pivotable handle to facilitate lifting of the right clamp off of the second magnet. Preferably, the present invention further comprises a left fiber insert and a right fiber insert; wherein the left fiber insert is situated directly underneath the acrylic plate of the left clamp and the right fiber insert is situated directly underneath the ferromagnetic plate of the right clamp; wherein the left fiber insert comprises a V-shaped channel with two vertical side walls and two angled bottom walls; and wherein a piece of coated fiber is inserted into the V-shaped channel such that when the left clamp is in a closed position, the coated fiber presses against the two vertical side walls of the V-shaped channel, the two angled bottom walls of the V-shaped channel, and the acrylic plate of the left clamp. The left fiber insert is preferably removably attached to the left platform.

In a preferred embodiment, the clamp assembly comprises a left clamp and a right clamp; the right clamp comprises a ferromagnetic plate, a bracket, a shaft, two springs, and two ball bearings; the shaft is connected to the bracket, and the ferromagnetic plate rotates on the shaft; and each ball bearing is situated between the shaft and one of the two springs, and each spring is situated between one of the ball bearings and the ferromagnetic plate. Preferably, the present invention further comprises a main body comprised of a single piece of aluminum alloy. The right moveable stage is preferably part of the main body.

In a preferred embodiment, the present invention further comprises a main body with inner walls; wherein the central moveable stage is connected to the inner walls of the main body by flexures that are suspended between the central moveable stage and the inner walls of the main body; wherein the diamond component comprises a bracket; and wherein the central moveable stage is connected to the bracket of the diamond component. Preferably, the present invention further comprises a main body with inner walls; wherein the central moveable stage is connected to the inner walls of the main body by flexures that are suspended between the central moveable stage and the inner walls of the main body; wherein a voice coil motor causes the central moveable stage to move the diamond oscillator forward; and wherein the forward movement of the diamond oscillator is controlled by a microprocessor in communication with a first strain gauge located on one of the flexures.

In a preferred embodiment, the present invention further comprises a main body with inner walls and further comprising a tension solenoid with a plunger; wherein the plunger is in contact with a transducer that is connected to the right moveable stage; and wherein the right moveable stage comprises flexures that are suspended between the inner walls of the main body and connected to the right moveable stage. Preferably, the tension solenoid causes the plunger to move forward, the plunger causes the transducer to move laterally, and when the transducer moves laterally, it causes the right moveable stage to move laterally. The lateral movement of the right moveable stage is preferably controlled by a microprocessor in communication with a second strain gauge located on the transducer and a third strain gauge located on one of the flexures.

In a preferred embodiment, the diamond is situated at a certain height relative to the piece of bare glass fiber, and the height of the diamond relative to the piece of bare glass fiber is adjustable.

In a preferred embodiment, the present invention is a fiber cleaving device comprising a clamp assembly; a central moveable stage; a right moveable stage; and a diamond component; wherein the diamond component comprises a diamond and a diamond oscillator; wherein the diamond comprises a cutting edge, and the clamp assembly secures a piece of bare glass fiber so that it is oriented roughly perpendicularly to the cutting edge of the diamond; wherein the central moveable stage moves the diamond oscillator forward so that the cutting edge of the diamond comes into contact with the piece of bare glass fiber; wherein the right moveable stage pulls the piece of bare glass fiber taught after it has been secured by the clamp assembly; and wherein the diamond oscillator is configured so that the diamond cleaves the piece of bare glass fiber at an effective cutting angle in the range of thirty to sixty degrees.

In a preferred embodiment, the diamond oscillator comprises an oscillator table, a lower oscillator leg, and an upper oscillator leg; the lower and upper oscillator legs are at an angle in the range of thirty to sixty degrees relative to the oscillator table; the diamond oscillator is connected to a coil core; the diamond is attached to the oscillator table, and the oscillator table comprises a tabletop and a table base; narrow gaps exist between the coil core and the lower oscillator leg and between the coil core and the table base; a coil is wrapped around part of the coil core; when current pulses flow through the coil, corresponding magnetic flux flows across the narrow gaps between the coil core and lower oscillator leg and between the coil core and table base, generating force of attraction impulses between the coil core and table base and between the coil core and lower oscillator leg; and the diamond oscillator has a resonant frequency, and the force of attraction impulses are set at approximately the resonant frequency of the diamond oscillator.

### BRIEF DESCRIPTION OF THE DRAWINGS

FIG. 1 is a top view of the present invention with the diamond component and right moveable stage in a first position.

FIG. 2 is a top view of the present invention with the diamond component and right moveable stage in a second position.

FIG. 3 is a left side view of the present invention.

FIG. 4 is a right side view of the present invention.

FIG. 5 is a front view of the present invention.

FIG. 6 is a perspective view of the present invention with the left and right clamps in an open position.

FIG. 7 is a bottom view of the present invention with the bottom cover removed to show the printed circuit board.

FIG. 8 is a bottom view of the present invention with the bottom cover and printed circuit board removed and the diamond component and right moveable stage in a first position.

FIG. 9 is a bottom view of the present invention with the bottom cover and printed circuit board removed and the diamond component and right moveable stage in a second position.

FIG. 9A is a partial perspective view of the present invention showing the flexures of the central moveable stage.

FIG. 9B is a partial perspective view of the present invention showing the flexures of the right moveable stage.

FIG. 10 is a perspective view of the diamond component in relation to the fiber.

FIG. 11 is a detail perspective view of the diamond component in relation to the fiber.

FIG. 12 is a front view of the diamond in relation to the fiber.

FIG. 13 is a top view of the diamond in relation to the fiber.

FIG. 13A is an illustration of the cutting motion of the diamond in relation to the fiber.

FIG. 13B is an illustration of the effective cutting angle of the diamond in relation to the fiber.

FIG. 14 is a side view of the diamond component with the side cover removed.

FIG. 15 is a side view of the diamond oscillator and coil core.

FIG. 16 is a first detail view of the diamond and oscillator table in relation to the fiber.

FIG. 17 is a second detail view of the diamond and oscillator table in relation to the fiber.

FIG. 18 is an exploded perspective view of a preferred embodiment of the right clamp.

FIG. 19 is a section view of the preferred embodiment of the right clamp.

FIG. 20 is a top view of the present invention with the top and bottoms covers removed.

### REFERENCE NUMBERS

1 Top cover

2 Bottom cover

3 Left clamp

3a Acrylic plate (of left clamp)

3b Scale (of left clamp)

3c Ferromagnetic shaft (of left clamp)

3d Shaft (of plastic clamp handle)

4 Right clamp

4a Ferromagnetic plate (of right clamp)

5 Left platform

6 Right moveable stage

7 Left fiber insert

8 Right fiber insert

9 Fiber

10 First magnet

11 Second magnet

12 Plastic handle (of clamp)

13 Diamond component

14 Main body

15 Power connector

16 Housing (of left fiber insert)

17 Channel (in housing)

18 First flat plate (of right fiber insert)

19 Divide

20 Second flat plate (of ferromagnetic plate of right clamp)

21 Cleave button

22 Ready light

23 Battery light

24 Clamp magnet

25 Central moveable stage

26 Flexure (of central moveable stage)

27 Bracket (of diamond component)

28 Voice coil motor magnet

28a Voice coil motor coil

29 First strain gauge

29a Terminal pad (of first strain gauge)

30 Tension solenoid

31 Plumger

32 Transducer

33 Second strain gauge

33a Terminal pad (of second strain gauge)

34 Third strain gauge

34a Terminal pad (of third strain gauge)

35 Flexure (of right movable stage)

36 Screw (for fiber insert mounting)

37 Side cover (of diamond component)

38 Frame (of diamond component)

39 Diamond

40 Cutting edge (of diamond)

41 Oscillator table

42 Diamond oscillator

43 Upper oscillator leg

44 Lower oscillator leg

45 Tabletop

46 Table base

47 Gap (between tabletop and table base)

48 Coil

48a Leads (of coil)

49 Coil core

50 Narrow gap (between coil core and table base and between coil core and lower oscillator leg)

51 Hinge (of oscillator leg)

52 Gap (between coil core and upper oscillator leg)

53 Printed circuit board

54 Lithium ion battery

55 Main microprocessor

56 USB interface microprocessor

57Cleave button connector

58 Voice coil motor connector

59 Diamond coil connector

60 Tension solenoid connector

61 First strain gauge connector

62 Second and third strain gauge connector

63 Set screw (for pushing coil core and diamond oscillator against frame)

64 USB connector

65 Motion direction of diamond

66 Spring (of right clamp)

67 Ball bearing (of right clamp)

68 Shaft (of right clamp)

69 Bracket (of right clamp)

70 Set screw (for adjusting height of diamond component)

71 Screw (for holding coil of voice coil motor to central moveable stage)

72 Screw (for attaching central moveable stage to bracket)

### DETAILED DESCRIPTION OF INVENTION

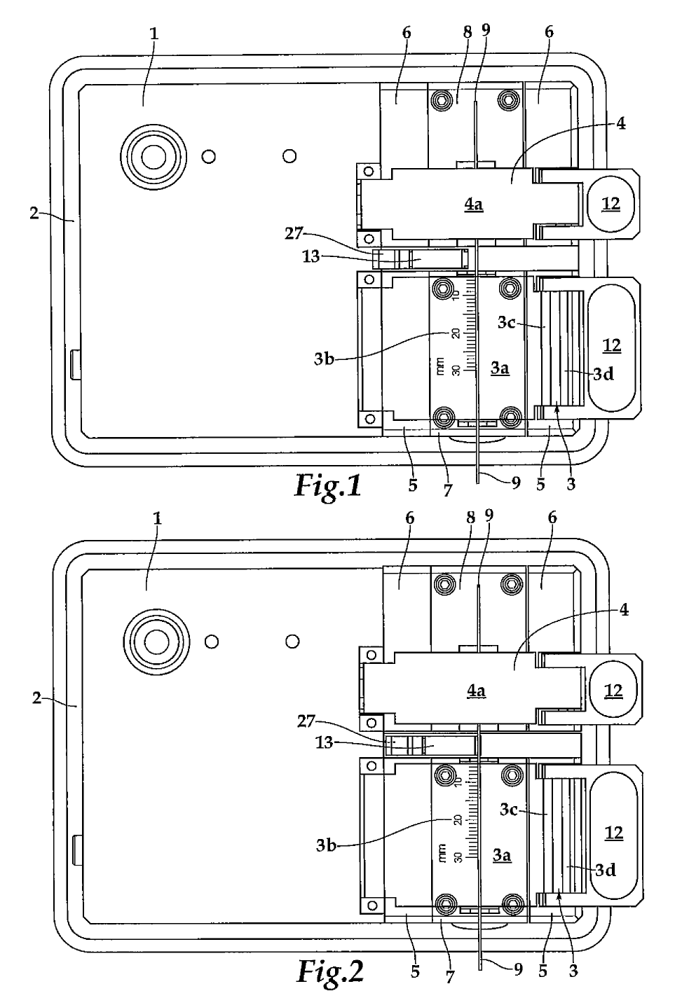

FIG. 1 is a top view of the present invention with the diamond component and right moveable stage in a first position. As shown in this figure, the present invention comprises a top cover 1, a bottom cover 2, a left clamp 3, a right clamp 4 a left platform 5 a right moveable stage 6 a left fiber insert 7and a right fiber insert 8. The left clamp 3 is preferably comprised of an acrylic plate 3a with a scale 3b that is used to measure the length of the exposed glass section of fiber 9. Typically, a two-inch length of the outer acrylate coating is stripped from the glass fiber prior to cleaving, and the coated fiber is positioned in the left fiber insert 7, channel 17, and clamped with the left clamp 3. The transition point where the fiber was stripped is visible through the acrylic plate next to the scale 3b. The scale measures the length of the exposed glass after cleaving. The right and left clamps are referred to herein as the “clamp assembly.”

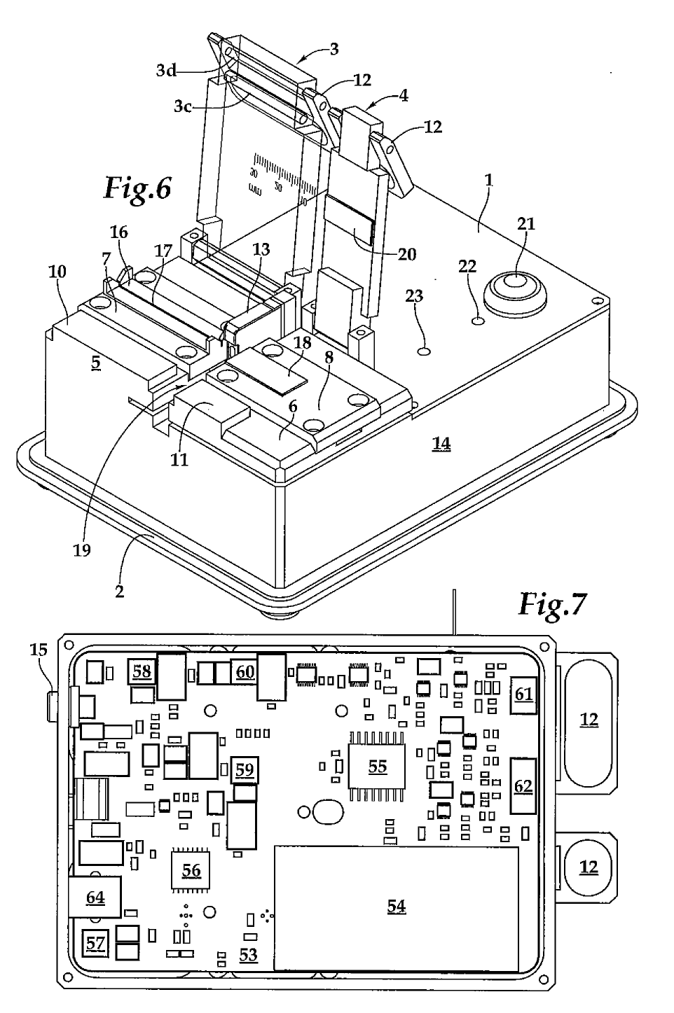

A ferromagnetic shaft 3c inside the acrylic plate 3a is positioned on top of a first magnet 10 (see FIG. 6) to provide the clamping force when the clamp is in a closed position, thereby securing the clamp in place. The right clamp 4 is preferably comprised of a ferromagnetic plate 4a, one end of which is positioned on top of a second magnet 11 (see FIG. 6), which provides the clamping force when the clamp is in a closed position, thereby securing the clamp in place. Both clamps preferably comprise plastic handles 12 to facilitate the lifting of the clamps from the magnets. The shafts about which the plastic handles of the left and right clamps 3 rotates are labeled as reference number 3d; these shafts are preferably ferromagnetic as well.

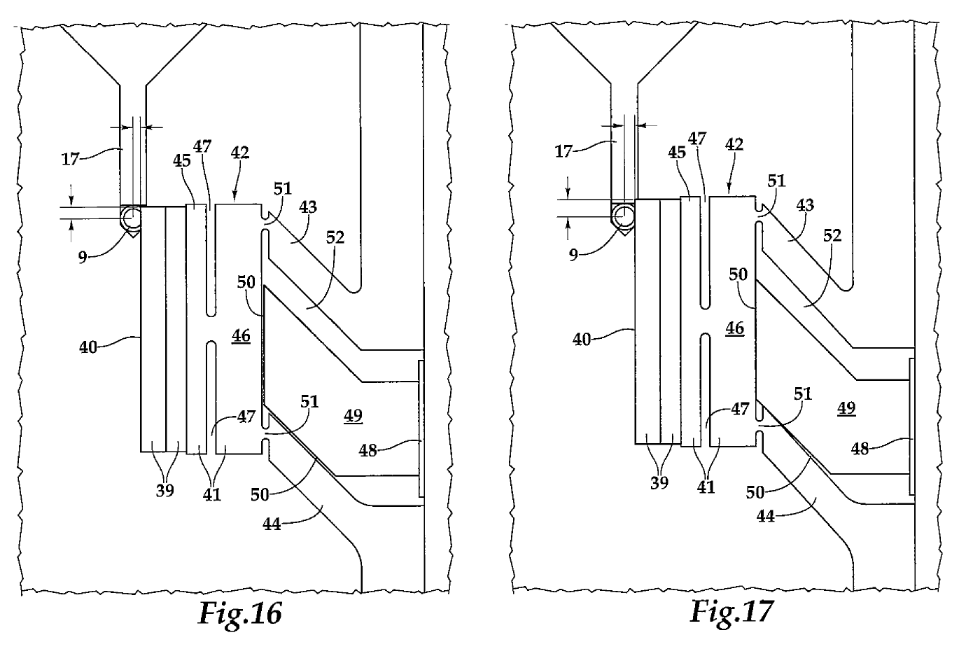

The clamping system of the present invention is unique in that most prior art clamping systems simply apply pressure on the fiber between two parallel faces; this method, however, squeezes the fiber to such an extent as to disturb the soft buffer layer around the glass core of the fiber. The present invention, on the other hand, locates the coated fiber in a close-fitting slot with a V-shaped bottom with the clamp pressing downward on the coated fiber from above. (In FIGS. 16 and 17, the clamps are omitted for clarity, but the line directly above the fiber represents the clamp on top of the coated fiber.) This configuration has the effect of pressing on the coated fiber from five sides (the two vertical side walls of the channel 17, the two sides of the “V” in the bottom of the channel 17, and the top, where the clamp 3 presses downward on the fiber) instead of two. The clamping pressure afforded by the present invention changes the shape of the fiber to a slightly oval shape until it contacts both side walls of the channel 17 (see Figure and then becomes rigid and strongly resistant to any further deformation (for ease of illustration, the “slightly oval shape” is not shown in FIGS. 16 and 17). At this point, the fiber is strongly clamped, and it has been only slightly deformed due to its close fit within the channel 17. By contrast, the commonly used clamping systems simply crush the fiber to achieve clamping, which in turn damages the integrity of the fiber. Note that the clamping action effectuated by the right clamp 4 on the bare glass is similar to prior art in that the fiber 9 is not situated in a channel 17. In this instance, there is no need to protect the bare glass because it is hard and resists crushing. This section of the fiber is cleaved off and not used.

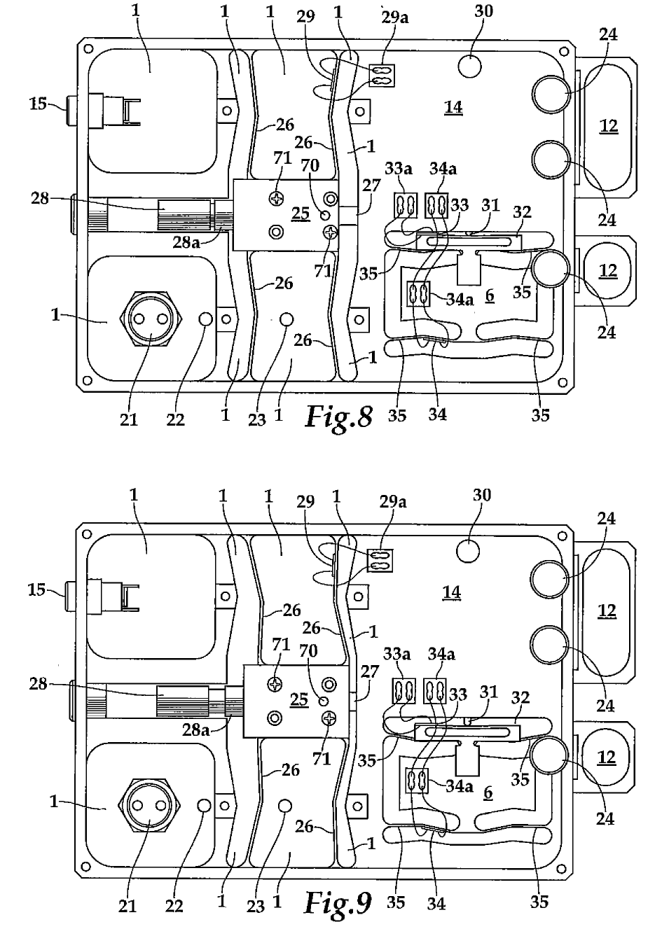

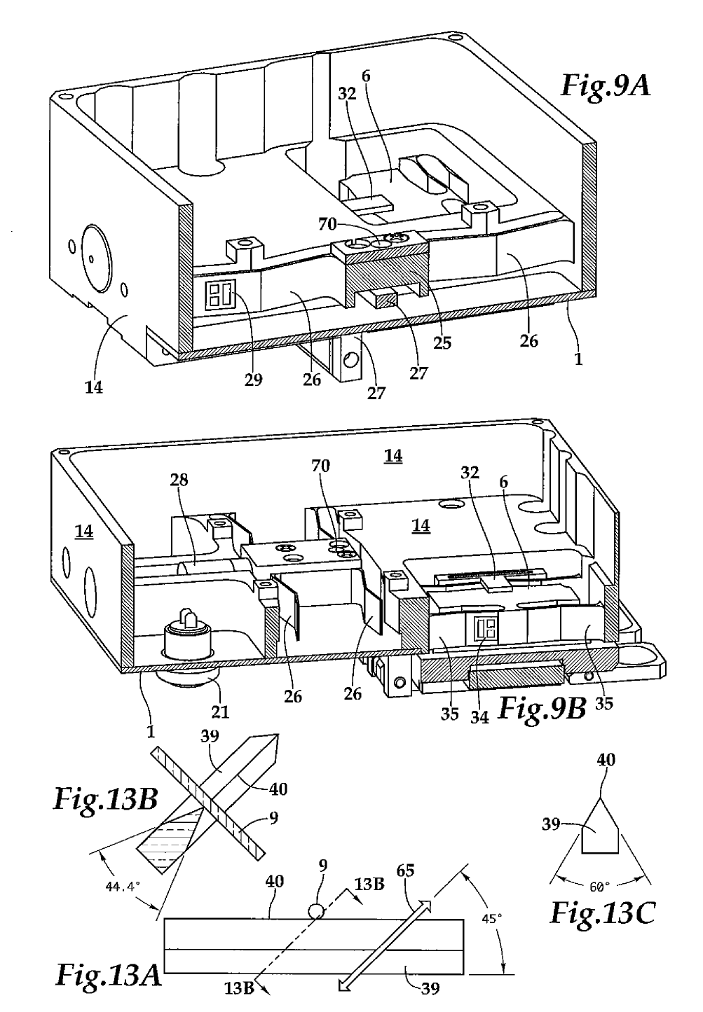

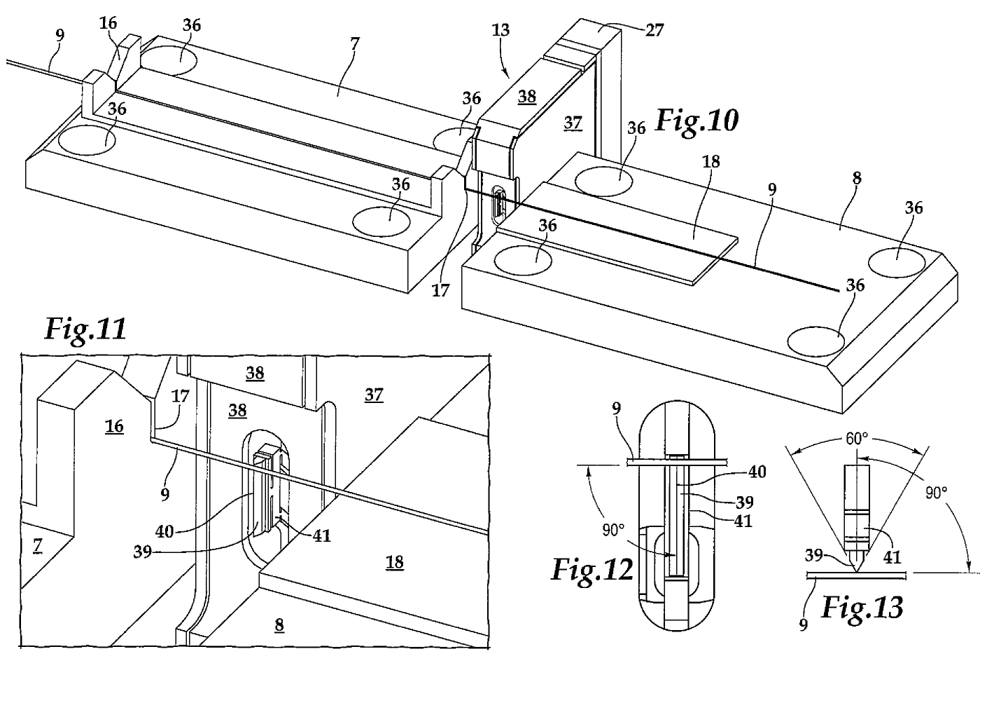

Referring to FIG. 1, the present invention further comprises a diamond component 13 that contains an oscillating diamond with a cutting edge that is used to cleave the fiber 9. The diamond component is shown more clearly in FIGS. 10-17. As illustrated in FIG. 2, the diamond component may be advanced toward the fiber 9 for purposes of cleaving. The mechanism by which the diamond component 13 is advanced toward the fiber 8 is shown in FIGS. 8 and 9.

The right moveable stage 6 is used to pull the fiber 9 taught once the fiber is placed inside the left fiber insert 7 and secured with the left and right clamps 3, 4 (see FIG. 10 for the placement of the fiber 9 in the left fiber insert 7). Specifically, the right moveable stage 6 may be moved slightly outward in relation to the left fiber insert 7, as shown in FIG. 2. The mechanism by which the right moveable stage 6 is moved outward in relation to the diamond component 13 is shown in FIGS. 8 and 9.

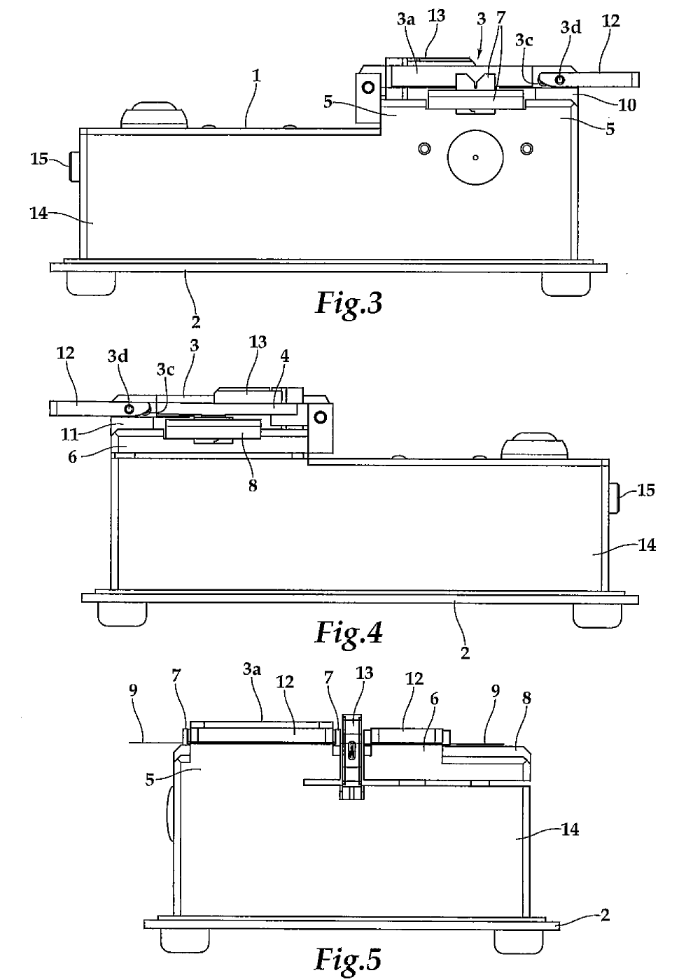

FIG. 3 is a left side view of the present invention. This figure shows the main body 14 of the present invention and the power connector 15. It also shows the left clamp 3, the left fiber insert 7, the first magnet 10, and the ferromagnetic shaft 3c inside the acrylic plate 3a of the left clamp 3. As shown in this figure, the left platform 5 is actually part of the main body 14 of the invention. In a preferred embodiment, the main body 14 is comprised of a single piece of aluminum alloy.

FIG. 4 is a right side view of the present invention. In addition to the main body 14 and power connector 15, this figure shows the right clamp 4, the second magnet 11, the right fiber insert 8, and the right moveable stage 6. In a preferred embodiment, the right moveable stage 6 is also part of the main body 14, but it is able to move in relation to the rest of the main body 14, for the reasons shown and described in connection with FIGS. 8 and 9.

FIG. 5 is a front view of the present invention. This figure shows the main body 14, the left platform 5, the right moveable stage 6, and the diamond component 13. It also shows the left fiber insert 7 and the right fiber insert 8. The handles 12 of the left and right clamps are also shown.

FIG. 6 is a perspective view of the present invention with the left and right clamps in an open position. As shown in this figure, the left fiber insert 7 comprises a housing 16 with a channel 17 into which the fiber 9 is placed prior to cleaving (the channel 17 is shown in greater detail in FIGS. 16 and 17). When the left clamp 3 is properly adjusted, the acrylic plate 3 a will come into contact with the fiber 9 when the left clamp 3 is in a closed position. The right fiber insert 8 comprises a first flat plate 18 that is horizontally aligned with the housing 16 of the left fiber insert 7 such that the bare glass fiber will lie across the first flat plate 18 of the right fiber insert 8 when the coated fiber is inserted into the channel 17 in the housing 16. Thus, the fiber 9 will extend across the housing 16 via the channel 17, across a divide 19 between the left fiber insert 7 and the right fiber insert 8, and onto the first flat plate 18 of the right fiber insert 8. (The diamond component 13 is located in the divide 19 between the left and right fiber inserts 7, 8.) The ferromagnetic plate 4a of the right clamp comprises a second flat plate 20 (integral to the ferromagnetic plate 4a ) on the underside of the ferromagnetic plate 4a. The second flat plate 20 is positioned such that when the right clamp 4 is closed, the second flat plate 20 lies directly on top of the first flat plate 18, thereby securing the bare glass fiber between the first and second flat plates 18, 20. As the right moveable stage is moved to the right (away from the diamond component 13), the fiber is pulled taught.

FIG. 6 also shows the cleave button 21, the ready light 22, and the battery light 23. The cleave button 21 is used to start the cleave cycle by first tensioning the clamped fiber, activating the diamond oscillator 42, moving the diamond component 13 forward until the diamond contacts the fiber and cleaving occurs. Cleaving is detected by the third strain gauge 34 signal and the cycle ends and resets, awaiting the next cleave start. The ready light 22 indicates that the unit is activated and ready to cleave, and the battery light 23 indicates when the battery needs to be recharged. In a preferred embodiment, the invention can run either on electricity via the power connector 15 or on battery power via the battery 54 (see FIG. 7).

FIG. 7 is a bottom view of the present invention with the bottom cover removed to show the printed circuit board. The present invention is not limited to any particular configuration of the printed circuit board 53; however, FIG. 7 is provided by way of illustration. As shown in this figure, the printed circuit board comprises a lithium ion battery 54, a main microprocessor 55, and a USB interface microprocessor 56. The purpose of the USB interface microprocessor 56 is to manage communications between the main microprocessor 55 and a laptop computer. It also shows the cleave button connector 57, the voice coil motor connector 58, the diamond coil connector 59 (which connects to the coil 48), the first strain gauge connector 61 (which connects to the first strain gauge 29), and the second and third strain gauge connector 62 (which connects to the second strain gauge 33 and third strain gauge 34).

FIG. 8 is a bottom view of the present invention with the bottom cover and printed circuit board removed and the diamond component and right moveable stage in a first position. FIG. 9 is a bottom view of the present invention with the bottom cover and printed circuit board removed and the diamond component and right moveable stage in a second position. These figures show the clamp magnets 24 that form the first and second magnets 10, 11 on the left platform 5 and right movable stage 6, respectively.

The mechanism by which the diamond component 13 is advanced toward the fiber 9 is shown in FIGS. 8 and 9. The invention comprises a central moveable stage 25 that is connected to the inner walls of the main body 14 by thin flexures 26 that are preferably bent in the center so as to facilitate movement. The flexures 26 are suspended between the central moveable stage-25 and the inner walls of the main body 14 (see FIG. 9A). The central moveable stage 25 is connected to a bracket 27 that forms part of the diamond component 13. Thus, when the central moveable stage 25 is moved forward (to the right in FIG. 8), the diamond component 13 also moves forward, toward the fiber 9. A voice coil motor comprising a magnet 28 and a coil 28a moves the central moveable stage 25 forward. A first strain gauge 29 measures the force applied to one of the thin flexures 26 as the central moveable stage 25 moves forward and transmits that information to the main microprocessor 55 (see FIG. 7). The main microprocessor 55 controls when, to what degree, and at what speed the central moveable stage 25 is moved forward.

The mechanism by which the right moveable stage 6 is moved outward is also shown in FIGS. 8 and 9. The invention comprises a tension solenoid 30 that causes the plunger 31 of the solenoid 30 to move outward (or downward in relation to FIG. 8), thereby pushing against a transducer 32 that is in turn connected to the right moveable stage 6 (also shown in FIG. 6). The right moveable stage 6 comprises thin flexures 35 (similar to the thin flexures of the central moveable stage 26) that are bendable. The flexures of both the central moveable stage 25 and the right moveable stage 6 are designed to allow the stages to move laterally with maximum smoothness and are maintenance-free.

The thin flexures 35 of the right moveable stage 6 are suspended between the inner walls of the main body 14 on either end and connected to the right moveable stage 6 in the center (see FIG. 9B). A second strain gauge 33 measures the force applied to the transducer 32 when the plunger 31 pushes it outward (i.e., total force applied by the solenoid 30), and a third strain gauge 34 measures the force applied to one of the thin flexures 35 as the right moveable stage 6 is moved outward by the transducer 32 (i.e., force required to move the stage). The second and third strain gauges 33, 34 transmit this information to the main microprocessor 55 (see FIG. 7), which regulates whether, to what degree, and at what speed the right moveable stage 6 is moved outward. The actual force that is applied to the fiber 9 is the force measured by the second strain gauge 33 minus the force measured by the third strain gauge 33.

FIG. 10 is a perspective view of the diamond component in relation to the fiber. The left and right fiber inserts 7, 8 are preferably attached to the left platform 5 and right moveable stage 6, respectively, with screws 36 so that the fiber inserts can be replaced to accommodate different sizes of fibers. The diamond component 13 comprises side covers 37 under which lies a frame 38. The frame 38 is attached to the bracket 27, which is in turn connected to the central moveable stage 25, as described above in connection with FIG. 8.

FIG. 11 is a detail perspective view of the diamond component in relation to the fiber. As shown in this figure, in addition to the side covers 37 and frame 38, the diamond component 13 comprises a diamond 39 with a cutting edge 40. The diamond 39 is preferably attached to an oscillator table 41 with epoxy. As shown in subsequent figures, the oscillator table 41 causes the diamond 39 to oscillate in a forty-five-degree (45°) motion. The height of the diamond component 13 is preferably adjusted so that when the diamond 39 moves forward horizontally, the cutting edge 40 of the diamond will come into contact with the fiber 9. Over time, the height of the diamond 39 may be adjusted so that the fiber 9 comes into contact with the cutting edge 40 of the diamond 39 at a different point along the cutting edge 40 (in this case, it would be lower on the cutting edge than what is shown in FIG. 11). The height of the diamond 39 is adjusted with a set screw 70 that pushes up against the bracket 27 from below.

FIG. 12 is a front view of the diamond in relation to the fiber. As shown in this figure, to achieve optimal cleaving, the fiber should be perpendicular to the cutting edge of the diamond. FIG. 13 is a top view of the diamond in relation to the fiber. As shown in this figure, to achieve optimal cleaving, the fiber should be perpendicular to the bisector of the cutting angle of the diamond. In a preferred embodiment, the cutting edge of the diamond is at a sixty-degree (60°) angle on either side of the bisector, as shown in FIG. 13.

FIG. 13A is an illustration of the cutting motion 65 of the diamond in relation to the fiber. As shown in this figure, the diamond 39 oscillates at a forty-five-degree (45°) angle. FIG. 13B is an illustration of the effective cutting angle of the diamond in relation to the fiber. As shown in this figure, the effective cutting angle of the diamond is forty-four and four-tenths degrees (44.4°). FIG. 13C is an illustration of the cutting edge of the diamond 39.

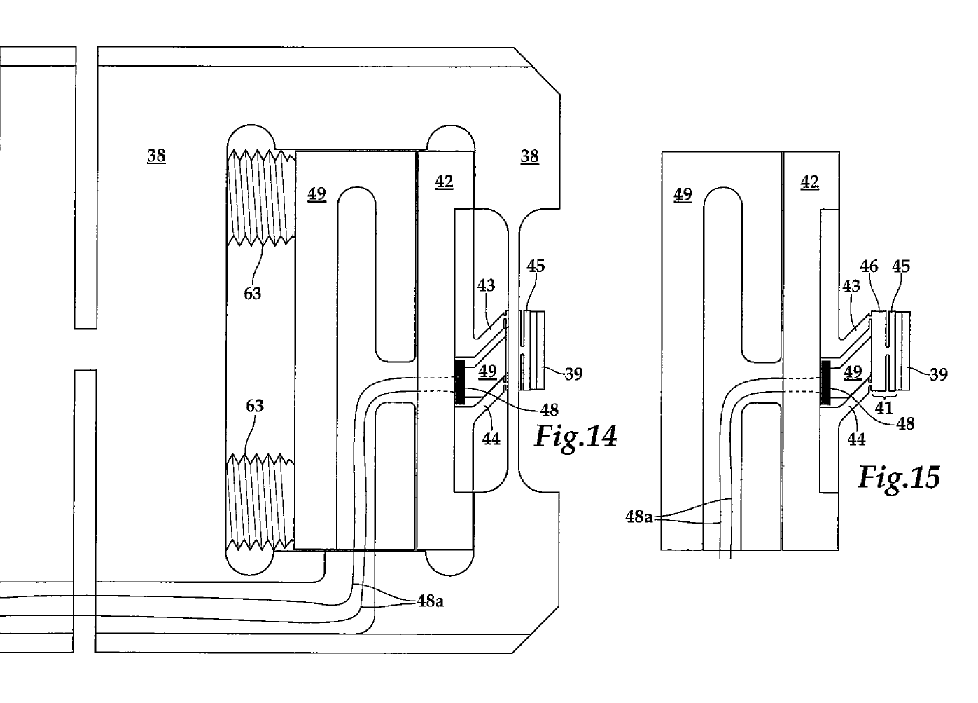

FIG. 14 is a side view of the diamond component with the side cover removed, and FIG. 15 is a side view of the diamond oscillator and coil core. As shown in these figures, the diamond 39 is attached (preferably with epoxy) to an oscillator table 41. The diamond oscillator 42 is comprised of the oscillator table 41, a lower oscillator leg 44, and an upper oscillator leg 43. A coil 48 is wrapped around part of the coil core 49, and its leads 48a extend through a channel in the coil core 49 to a connector on the printed circuit board 53. The function of the coil 48 is described in connection with FIGS. 16 and 17 below. Two set screws 63 push the coil core 49 and the diamond oscillator 42 against the frame 38, locking all components in place.

FIG. 16 and 17 are detail views of the diamond 39 and oscillator table 41 in relation to the fiber 9. The purpose of these figures is to show the movement of the diamond 39 on the oscillator table 41 during oscillation. As explained in connection with FIGS. 14 and 15, the diamond oscillator 42 comprises the oscillator table 41, the lower oscillator leg 44, and the upper oscillator leg 43. The oscillator table 41 comprises a tabletop 45 and a table base 46. The lower and upper oscillator legs 44, 43 are at forty-five-degree (45°) angles to the table base 46, and they are connected to the table base 46 by narrow hinges 51 that allow the legs 44, 43 to flex relative to the table base 46. Upper and lower gaps 47 between the tabletop 45 and table base 46 allow the tabletop to flex slightly, thereby alleviating stress on the diamond.

The oscillator table 42 is preferably comprised of a ferromagnetic material suitable for the conduction of a magnetic flux. The coil core 49 is preferably comprised of a separate piece of the same ferromagnetic material. One end of the coil 48 is wrapped around the coil core 49 and is connected to the printed circuit board 53 via the diamond coil connector 59 (see FIG. 7). Narrow gaps 50 exist between the coil core 49 and the lower oscillator leg 44 and between the coil core 49 and the table base 46. When current pulses flow through the coil 48, corresponding magnetic flux flows across the narrow gaps 50, generating force of attraction impulses between the coil core 49 and table base 46. Similarly, forces of attraction impulses are generated between the coil core 49 and lower oscillator leg 44. These forces of attraction pull down on the table base 46 and also pull on the lower oscillator leg, displacing the diamond 39 as shown in FIG. 17. FIG. 16 illustrates the position of the diamond 39 when the coil is de-energized. These impulses are set approximately at the resonant frequency of the oscillator, providing the required energy for the oscillation. (The gap 52 between the coil core 49 and the upper oscillator leg 44 is preferably too large to generate a corresponding force impulse in the upper oscillator leg 45.) The oscillator table 42 is preferably designed so that it resonates at approximately fifty (50) kilohertz (kHz).

In a preferred embodiment, pulse-width modulation is used under computer (i.e., microprocessor) control to generate the current pulses. The resonant frequency of the diamond oscillator 42 is affected by ambient temperature fluctuations due to the effect of temperature on the stiffness of the ferromagnetic material used. A decrease in ambient temperature will increase the resonant frequency of the diamond oscillator 42, and conversely, an increase in ambient temperature will decrease the resonant frequency. This effect is compensated for by first measuring the ambient temperature and then applying a correction factor to the driving frequency.

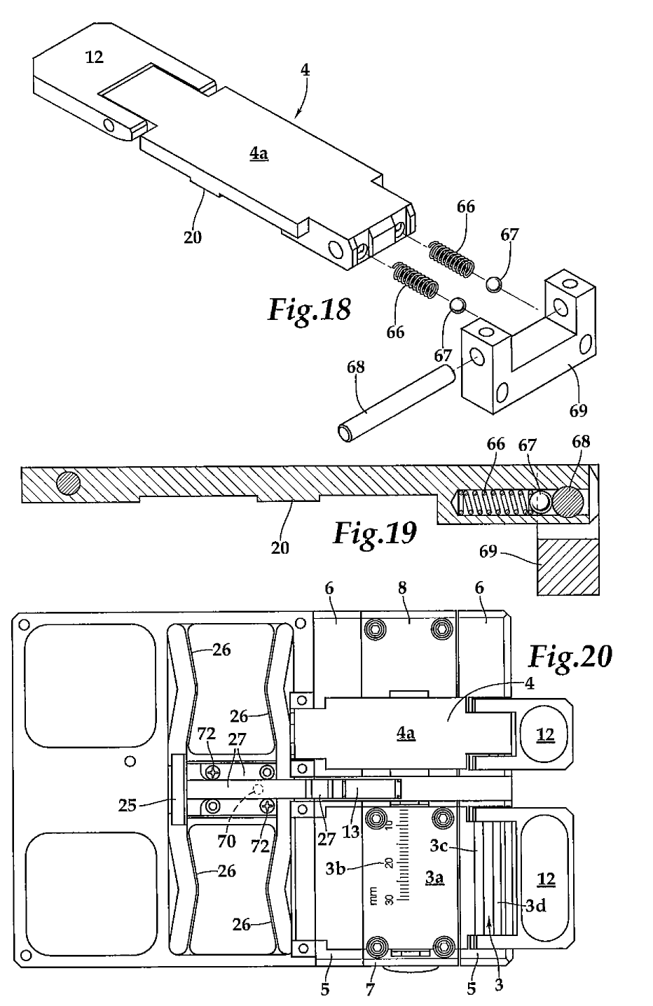

FIG. 18 is an exploded perspective view of a preferred embodiment of the right clamp. In this embodiment, the right clamp 4 comprises a ferromagnetic plate 4a and a plastic handle 12. It also comprises two springs 66, two ball bearings 67, a shaft 68, and a bracket 69. FIG. 19 is a section view of the preferred embodiment of the right clamp. This figure shows one of the two springs 66, one of the two ball bearings 67, the shaft 68, and the bracket 69. Both figures also show the second flat plate 20 on the underside of the right clamp 4. The purpose of this clamp design is to minimize any looseness in the clamp as it rotates about its shaft when clamping down on the fiber. Any longitudinal movement of the clamp at contact with the fiber will rotate the fiber and create torsion stress. Cleaving the fiber under this condition will produce an unwanted angle in the cleave.

FIG. 20 is a top view of the present invention with the top and bottoms covers removed. The dotted circle 70 in this figure represents the set screw (not shown) that comes up from underneath the central moveable stage 25 (see FIG. 9) and abuts up against the bracket 27; as noted above, this set screw 70 is used to adjust the height of the diamond component 13. Two screws 71 shown in FIGS. 8 and 9 serve to hold the coil 28a of the voice coil motor to the central moveable stage 25. Two other screws 72 serve to attach the central moveable stage 25 to the bracket 27.

Although the preferred embodiment of the present invention has been shown and described, it will be apparent to those skilled in the art that many changes and modifications may be made without departing from the invention in its broader aspects. For example, although the preferred effective cutting angle of the diamond is roughly forty-five degrees (45°), the present invention is intended to cover a range of effective cutting angles from thirty to sixty degrees (30° to 60°). The appended claims are therefore intended to cover all such changes and modifications as fall within the true spirit and scope of the invention.

We claim:

1. A fiber cleaving device comprising:
(a) a clamp assembly;
(b) a central moveable stage;
(c) a right moveable stage; and
(d) a diamond component;
wherein the diamond component comprises a diamond and a diamond oscillator;
wherein the diamond comprises a cutting edge, and the clamp assembly secures a piece of bare glass fiber so that it is oriented roughly perpendicularly to the cutting edge of the diamond;
wherein the central moveable stage moves the diamond oscillator forward so that the cutting edge of the diamond comes into contact with the piece of bare glass fiber;
wherein the right moveable stage pulls the piece of bare glass fiber taught after it has been secured by the clamp assembly; and
wherein the diamond oscillator is configured so that the diamond cleaves the piece of bare glass fiber at an effective cutting angle of approximately forty-five degrees.

2. The fiber cleaving device of claim 1, wherein the diamond oscillator comprises an oscillator table, a lower oscillator leg, and an upper oscillator leg;
wherein the lower and upper oscillator legs are at a roughly forty-five-degree angle relative to the oscillator table;
wherein the diamond oscillator is connected to a coil core;
wherein the diamond is attached to the oscillator table, and the oscillator table comprises a tabletop and a table base;
wherein narrow gaps exist between the coil core and the lower oscillator leg and between the coil core and the table base;
wherein a coil is wrapped around part of the coil core;
wherein when current pulses flow through the coil, corresponding magnetic flux flows across the narrow gaps between the coil core and lower oscillator leg and between the coil core and table base, generating force of attraction impulses between the coil core and table base and between the coil core and lower oscillator leg; and
wherein the diamond oscillator has a resonant frequency, and the force of attraction impulses are set at approximately the resonant frequency of the diamond oscillator.

3. The fiber cleaving device of claim 2, wherein the oscillator table resonates at approximately fifty kilohertz.

4. The fiber cleaving device of claim 1, wherein the clamp assembly comprises a left clamp and a right clamp; and
wherein the left clamp comprises an acrylic plate with a scale that is used to measure the length of an exposed glass section of fiber.

5. The fiber cleaving device of claim 1, further comprising a main body;
wherein the main body comprises a first magnet and a second magnet;
wherein the clamp assembly comprises a left clamp and a right clamp;
wherein the left clamp comprises an acrylic plate with an embedded ferromagnetic shaft;
wherein the ferromagnetic shaft of the left clamp is situated directly on top of the first magnet when the left clamp is in a closed position;
wherein the right clamp comprises a ferromagnetic plate with a first end; and
wherein the first end of the ferromagnetic plate is situated directly on top of the second magnet when the right clamp is in a closed position.

6. The fiber cleaving device of claim 5, wherein the left clamp comprises a pivotable handle to facilitate lifting of the left clamp off of the first magnet, and the right clamp comprises a pivotable handle to facilitate lifting of the right clamp off of the second magnet.

7. The fiber cleaving device of claim 5, further comprising a left fiber insert and a right fiber insert;
wherein the left fiber insert is situated directly underneath the acrylic plate of the left clamp and the right fiber insert is situated directly underneath the ferromagnetic plate of the right clamp;
wherein the left fiber insert comprises a V-shaped channel with two vertical side walls and two angled bottom walls; and
wherein a piece of coated fiber is inserted into the V-shaped channel such that when the left clamp is in a closed position, the coated fiber presses against the two vertical side walls of the V-shaped channel, the two angled bottom walls of the V-shaped channel, and the acrylic plate of the left clamp.

8. The fiber cleaving device of claim 7, wherein the main body comprises a left platform; and
wherein the left fiber insert is removably attached to the left platform.

9. The fiber cleaving device of claim 1, wherein the clamp assembly comprises a left clamp and a right clamp;
wherein the right clamp comprises a ferromagnetic plate, a bracket, a shaft, two springs, and two ball bearings;
wherein the shaft is connected to the bracket, and the ferromagnetic plate rotates on the shaft; and
wherein each ball bearing is situated between the shaft and one of the two springs, and each spring is situated between one of the ball bearings and the ferromagnetic plate.

10. The fiber cleaving device of claim 1, further comprising a main body;
wherein the main body is comprised of a single piece of aluminum alloy.

11. The fiber cleaving device of claim 10, wherein the right moveable stage is part of the main body.

12. The fiber cleaving device of claim 1, further comprising a main body with inner walls;
wherein the central moveable stage is connected to the inner walls of the main body by flexures that are suspended between the central moveable stage and the inner walls of the main body;
wherein the diamond component comprises a bracket; and
wherein the central moveable stage is connected to the bracket of the diamond component.

13. The fiber cleaving device of claim 1, further comprising a main body with inner walls;
wherein the central moveable stage is connected to the inner walls of the main body by flexures that are suspended between the central moveable stage and the inner walls of the main body;
wherein a voice coil motor causes the central moveable stage to move the diamond oscillator forward; and
wherein the forward movement of the diamond oscillator is controlled by a microprocessor in communication with a first strain gauge located on one of the flexures.

14. The fiber cleaving device of claim 1, further comprising a main body with inner walls and further comprising a tension solenoid with a plunger;
wherein the plunger is in contact with a transducer that is connected to the right moveable stage; and
wherein the right moveable stage comprises flexures that are suspended between the inner walls of the main body and connected to the right moveable stage.

15. The fiber cleaving device of claim 14, wherein the tension solenoid causes the plunger to move forward, the plunger causes the transducer to move laterally, and when the transducer moves laterally, it causes the right moveable stage to move laterally.

16. The fiber cleaving device of claim 15, wherein the lateral movement of the right moveable stage is controlled by a microprocessor in communication with a second strain gauge located on the transducer and a third strain gauge located on one of the flexures.

17. The fiber cleaving device of claim 1, wherein the diamond is situated at a certain height relative to the piece of bare glass fiber, and the height of the diamond relative to the piece of bare glass fiber is adjustable.

18. A fiber cleaving device comprising:
(a) a clamp assembly;
(b) a central moveable stage;
(c) a right moveable stage; and
(d) a diamond component;
wherein the diamond component comprises a diamond and a diamond oscillator;
wherein the diamond comprises a cutting edge, and the clamp assembly secures a piece of bare glass fiber so that it is oriented roughly perpendicularly to the cutting edge of the diamond;
wherein the central moveable stage moves the diamond oscillator forward so that the cutting edge of the diamond comes into contact with the piece of bare glass fiber;
wherein the right moveable stage pulls the piece of bare glass fiber taught after it has been secured by the clamp assembly; and
wherein the diamond oscillator is configured so that the diamond cleaves the piece of bare glass fiber at an effective cutting angle in the range of thirty to sixty degrees.

19. The fiber cleaving device of claim 18, wherein the diamond oscillator comprises an oscillator table, a lower oscillator leg, and an upper oscillator leg;
wherein the lower and upper oscillator legs are at an angle in the range of thirty to sixty degrees relative to the oscillator table;
wherein the diamond oscillator is connected to a coil core;
wherein the diamond is attached to the oscillator table, and the oscillator table comprises a tabletop and a table base;
wherein narrow gaps exist between the coil core and the lower oscillator leg and between the coil core and the table base;
wherein a coil is wrapped around part of the coil core;
wherein when current pulses flow through the coil, corresponding magnetic flux flows across the narrow gaps between the coil core and lower oscillator leg and between the coil core and table base, generating force of attraction impulses between the coil core and table base and between the coil core and lower oscillator leg; and
wherein the diamond oscillator has a resonant frequency, and the force of attraction impulses are set at approximately the resonant frequency of the diamond oscillator.
